(19) United States
(12) Patent Application Publication
(10) Pub. No.: US 2025/0243921 A1
(43) Pub. Date: Jul. 31, 2025

(54) Rotational Dampener

(71) Applicant: Illinois Tool Works Inc., Glenview, IL (US)

(72) Inventors: Michael Adrian Tyler, Mokena, IL (US); Dennis Matthew Mark, Hawthorn Woods, IL (US); Jürgen Benno Hilpert, Riedenheim (DE); Stefan Erwin Fuchs, Gaukönigshofen OT Eichelsee (DE)

(21) Appl. No.: 19/007,739

(22) Filed: Jan. 2, 2025

Related U.S. Application Data
(60) Provisional application No. 63/626,847, filed on Jan. 30, 2024.

(51) Int. Cl. F16F 13/04

(52) U.S. Cl. CPC F16F 13/04; F16F 2222/04; F16F 2224/025; F16F 2232/02; F16F 2236/08

(57) ABSTRACT

Disclosed is a rotational spring dampener having a core, a first housing element, a second housing element, and a tensile member. The core includes an opening therethrough and a first plurality of bosses. The first housing element comprising a second plurality of bosses, while the second housing element comprising a third plurality of bosses. The first housing element and the second housing element form a housing assembly having a cavity therein, where the core is configured to pivot relative to the housing assembly. The tensile member is positioned within the cavity to dampen movement of the core relative to the housing assembly. The tensile member is connected to the core via the first plurality of bosses and to the first housing element via the second plurality of bosses. The tensile member is or comprises a solid silicon polymer. Each of the second plurality of bosses can define a cavity configured to receive one of a third plurality of bosses formed on the second housing element to define a press-fit assembly. The housing assembly can include an alignment groove to serve as a poka-yoke. The first housing element and the second housing element can be coupled to one another to form the housing assembly via one or more snap assemblies.

### RELATED APPLICATIONS

The present application claims priority to U.S. Provisional Patent Application No. 63/626,847, filed Jan. 30, 2024, and entitled “Rotational Dampener,” which is hereby incorporated by reference in its entirety.

### BACKGROUND

Rotational springs may be used in a variety of applications. For some applications, it is desirable to combine a rotational spring with a dampener. Dampeners may reduce the release velocity of a loaded rotational spring after it is released. Some dampeners may be particularly useful in combination with specific types of rotational springs. For example, typical silicone dampeners offer only low amounts of resistance torque and may only be suitable for use with low torque rotational springs, and not for use with high torque springs. Further, certain dampeners may not be well-suited for use in all situations, for example, in extreme temperatures.

A rotational spring dampener, in some examples, has a compression limiter, a first disk, and a second disk. For example, commonly-owned U.S. Patent Publication No. 2022/0056979A1 to Ooomen et al., for example, describes a silicone free rotational spring hinge dampener. Certain dampeners may not be well-suited for use in all situations, for example, in extreme temperatures. To that end, commonly-owned U.S. Patent Publication No. 2023/0258241A1 to Ooomen et al., for example, describes a high temperature, high torque, polymeric rotational dampener that uses a tensile member connected to the first disk and the second disk. The tensile member is composed of a solid silicon polymer.

Despite these advancements, a need exists for a further improved rotational dampener that, for example, is more compact, mitigates debris penetration, and allows for clockwise and counterclockwise operation.

### SUMMARY

The present disclosure relates generally to a rotational dampener, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a and 1b illustrate top perspective views of a dampener in accordance with an aspect of this disclosure.

FIG. 1c illustrates a side elevational view of the dampener of FIGS. 1a and 1b.

FIG. 1d illustrates a topside perspective assembly view of the dampener.

FIG. 1e illustrates an underside perspective assembly view of the dampener.

FIGS. 1f and 1g illustrate top perspective assembled and assembly views of a snap assembly of the dampener.

FIG. 1h illustrates a cross-sectional view taken along cut-line A-A (FIG. 1a) of a press-fit assembly of the dampener.

FIG. 1i illustrates a cross-sectional view taken along cut-line B-B (FIG. 1c) of the dampener.

FIGS. 2a and 2b illustrate top perspective views of a dampener in accordance with another aspect of this disclosure.

FIG. 2c illustrates a side elevational view of the dampener of FIGS. 2a and 2b.

FIG. 2d illustrates a topside perspective assembly view of the dampener.

FIG. 2e illustrates an underside perspective assembly view of the dampener.

FIG. 2f illustrates a cross-sectional view taken along cut-line C-C (FIG. 2a) of a press-fit assembly of the dampener.

FIG. 2g illustrates a cross-sectional view taken along cut-line D-D (FIG. 2c) of the dampener.

FIGS. 2h and 2i illustrate top perspective assembled and assembly views of a snap assembly of the dampener.

FIGS. 3a and 3b illustrate the dampeners installed on opposite sides of a vehicle seat.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a dampener that may be combined with a rotational spring to improve the performance of the spring. The term rotational spring is interchangeable with the term “torsion spring,” as used herein. Torsion springs are often coupled with a dampener such that the spring may drive a mechanical motion in a clockwise or counterclockwise direction while being dampened to control the spring's rotational velocity and/or resonant bounce. Such springs are often metallic coil springs or clock springs.

For some applications, low mass and low-level torque requirements may be adequately supplied by metal springs. However, when metal springs are used in applications with high torque requirements, specifications often necessitate the use of heavy gage wire to obtain the desired torque. This increases product mass and size/volume, which is often undesired. For example, in some applications, the packaging for the torsion spring and the dampener must be small to fit within a provided storage space and provide aesthetic satisfaction, while performing consistently over time, withstand temperature changes, and perform quietly. Additionally, for some applications, certain materials may not be suitable for use in a dampener. For example, in high-heat applications (such as temperatures above 108° F.), certain polymeric materials may become overly oriented (e.g., melt or exhibit an increase in pliability), which may lead to undesirable deformation (e.g., annealing or buckling) of the polymeric material. Embodiments of the present disclosure discussed herein address some of these deficiencies.

Some existing dampener devices known for use with hinge rotation of heavy vehicle components (e.g., vehicle doors, seats, tailgates, boot, and hatch back closures) may include: (1) linearly moving gas filled struts; (2) silicone gel viscosity dampers; (3) steel clock/coil springs; (4) friction dampeners, such as those using surface to surface friction to generate kinetic energy absorption (e.g., a Reell® friction damper); and (5) steel torsion bar dampeners, which are frequently configured as a viscous dampener having a steel bar that twists within a viscous material. However, these existing dampener devices have several problems and limitations.

For example, current gas strut solutions are typically crafted and designed using a metal tube cylinder and a piston that house high pressure gas. The motion control of the piston is limited to linear motion (e.g., straight-line) and/or non-rotary/pivoting motion. The gas structure may also include a linear strut that typically assists a separate simple hinge, such as, but not limited to a 4-bar link hinge and the like. Additionally, the design packaging required for gas struts and the strut solutions are typically larger than what can be accommodated in many applications (e.g., such as in a vehicle seat). Also, the seals used in piston and cylinder designs tend to leak over time, which results in a loss of gas pressure. The loss of pressure may cause gas strut solutions to fail or significantly reduce the performance of the gas strut over a short period of time. Moreover, gas struts tend to have a high cost due to their design and manufacturing complexity.

Silicone gel or viscosity dampers rely on the relatively high viscosity of the liquid or gel silicone to provide fluidic friction (e.g., resistance) for dampening. Dampening in rotary motion is typically limited to less than 1 Nm when silicone fluid housings are produced with thermoplastic construction, as is commonly known in the industry. When torque values above 1 Nm are needed, the use of metallic housing is typically required to contain the resulting pressure. Silicone gel or viscosity dampers further require fluidic seals positioned such that the gel does not leak over time and during cycling. Problematically, metallic housings are typically formed from diecast aluminum or zinc, which significantly increases the mass of the solution, rendering them unsuitable for many applications. Moreover, high-torque applications (such as vehicle seats, hatchbacks, and doors) may require the use of multiple silicone gel or viscosity dampers to provide the necessary dampening effect to all positions. Therefore, the problematic addition of mass associated with silicone gel or viscosity dampers would be multiplied if used in these applications, making such dampeners particularly unsuitable. Additionally, the silicone gel used in current rotary dampers is highly temperature dependent. In particular, the resistance torque of the silicone gel is measured at extreme temperatures, which effects the performance of the silicone gel dampeners at these temperatures. For example, at cold temperatures (such as below −40° F.), the viscosity of the silicone gel increases significantly and at hot temperatures (such as above 185° F.), the viscosity of the silicone gel is greatly reduced.

As another example of the shortcomings of known dampening devices, steel springs are sometimes used to counteract a motion inducing spring force or gravitational force acting on a heavy closure or seat back. The counter spring may be tuned to engage the moving application part way through the motion of the application, applying a negative force on the application that slows its velocity or rotational inertia (e.g., moment of inertia). While this is a popular solution, it has significant drawbacks. Such dampening springs do not perform well with fatigue cycling over time. Relatedly, the hardening of the steel springs hardens the steel material over time increasing the brittleness of the steel material, which may cause the steel spring to fail. As with other unsuitable dampeners, the use of metallic components typically results in packaging that is larger than what can be accommodated in many applications (such as in a vehicle seat), and in a device that is heavier than what can be accommodated in many applications. Additionally, steel springs are necessarily metallic, which can be noisy and generate buzz, squeak, and rattle (BSR) issues when used in vehicle interiors.

As still another example of the shortcomings of known dampening devices, friction dampeners typically use forces that are applied perpendicular to opposing surfaces, such that the friction is generated when the dampener is moved rotationally or linearly. The applied forces are typically induced by a coil metallic spring. Stress and wear on internal parts can be a major issue in these dampeners depending on the materials used to form the friction surfaces. This is especially true when less dense materials (e.g., viscoelastic and/or compressible rubber type materials) are used to for the friction surfaces. Alternatively, if more dense materials are used, the added weight may result in a dampening device that is heavier than what can be accommodated in many applications. Additionally, it is difficult to configure friction dampers to have a “free run-style dampening” (as described below), and any such configuration is likely to result in excessive size, complexity, and cost. The friction dampeners typically provide little to no torque in at least one direction (typically the counterclockwise direction) and may provide insufficient torque (such as 0.2 Nm of torque dampening) in the other direction (typically the clockwise direction). Further, friction dampers offer little to no spring dampening or torque assistance. Moreover, the engaging components of friction dampeners tend to lose torque over time when exposed to multiple heating/cooling cycles making the dampeners complete unusable in applications exposed to significant temperature swings. This wearing also shortens the life for these dampeners, often to unacceptable levels. Another issue with friction dampeners is that the resins used in friction dampening tend to anneal and creep over time and, as a result, the initial resistive friction forces of the dampeners are lost. Friction dampeners are also known to generate noise, especially squeaking, when used and are therefore undesirable for use in vehicle interiors.

The dampeners of the present disclosure discussed herein address some of these deficiencies. In one example, a rotational spring dampener comprises: a core comprising an opening therethrough and a first plurality of bosses; a first housing element comprising a second plurality of bosses; a second housing element comprising a third plurality of bosses, wherein the first housing element and the second housing element form a housing assembly having a cavity therein, and wherein the core is configured to pivot relative to the housing assembly; and a tensile member positioned within the cavity to dampen movement of the core relative to the housing assembly, wherein the tensile member is connected to the core via the first plurality of bosses and to the first housing element via the second plurality of bosses, and wherein the tensile member comprises a solid silicon polymer.

In another example, a rotational spring dampener comprises: a core comprising an opening therethrough and a first plurality of bosses; a first housing element comprising a second plurality of bosses; a second housing element configured to couple with the first housing element via one or more snap assemblies to form a housing assembly having a cavity therein, wherein the core is configured to pivot relative to the housing assembly; and a tensile member positioned within the cavity to dampen movement of the core relative to the housing assembly, wherein the tensile member is connected to the core via the first plurality of bosses and to the first housing element via the second plurality of bosses, and wherein the tensile member comprises a solid silicon polymer.

In yet another example, a rotational spring dampener comprises: a core comprising an opening therethrough and a first plurality of bosses; a first housing element comprising a second plurality of bosses; a second housing element configured to couple with the first housing element via one or more snap assemblies to form a housing assembly having a cavity and a pair of ear portions, wherein the core is configured to pivot relative to the housing assembly and each of the pair of ear portions defines a fastener hole; and a tensile member positioned within the cavity to dampen movement of the core relative to the housing assembly, wherein the tensile member is connected to the core via the first plurality of bosses and to the first housing element via the second plurality of bosses, and wherein the tensile member comprises a solid silicon polymer.

In some examples, the housing assembly comprising one or more alignment grooves.

In some examples, the first housing element and the second housing element are coupled to one another to form the housing assembly via one or more snap assemblies.

In some examples, the one or more snap assemblies comprises a first snap component coupled to the first housing element and a second snap component coupled to the second housing element.

In some examples, one of the first snap component and the second snap component includes a clip and another one of the first snap component and the second snap component includes a window configured to engage the clip.

In some examples, the housing assembly is generally cylindrical and defines a sidewall, wherein the one or more snap assemblies are positioned on the sidewall.

In some examples, each of the second plurality of bosses defines a cavity configured to receive one of the third plurality of bosses to define a press-fit assembly.

In some examples, each of the third plurality of bosses comprise a distal end that is tapered.

In some examples, the housing assembly is configured for installation in a recess of a vehicle seat in a first position where the first housing faces outwardly and a second position where the second housing faces outwardly.

In some examples, the exterior surfaces of the first plurality of bosses and the second plurality of bosses are polished to reduce friction with the tensile member.

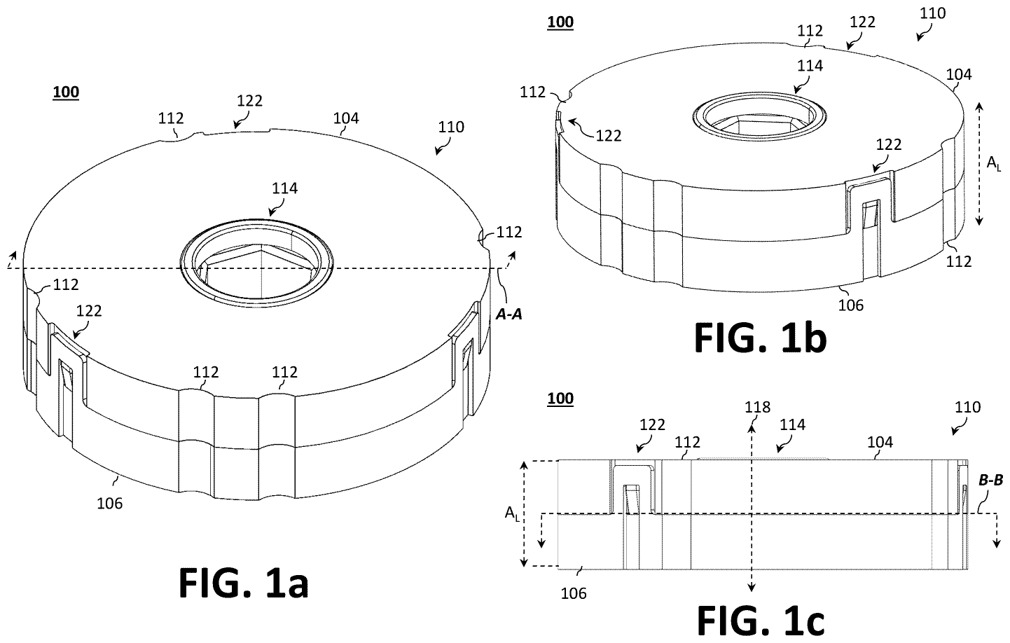

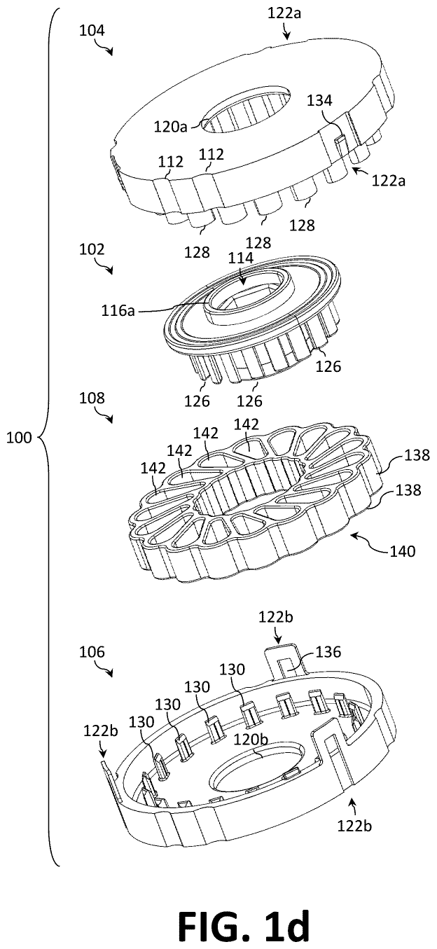

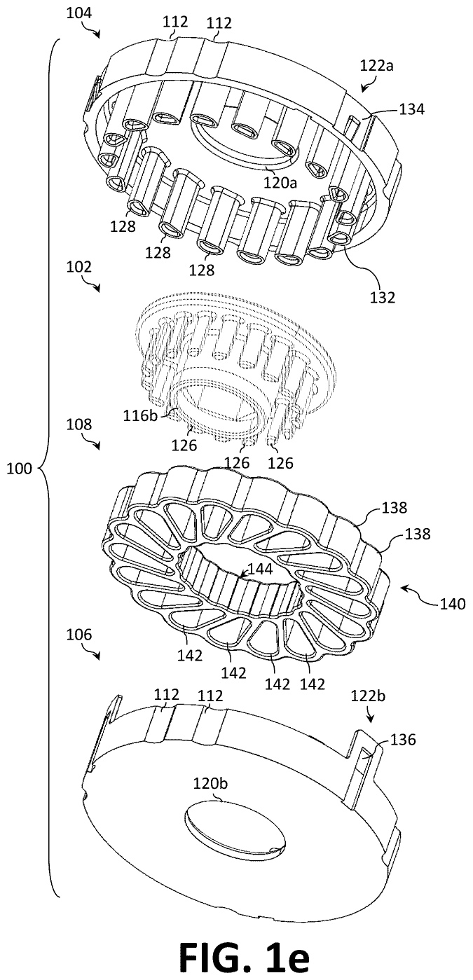

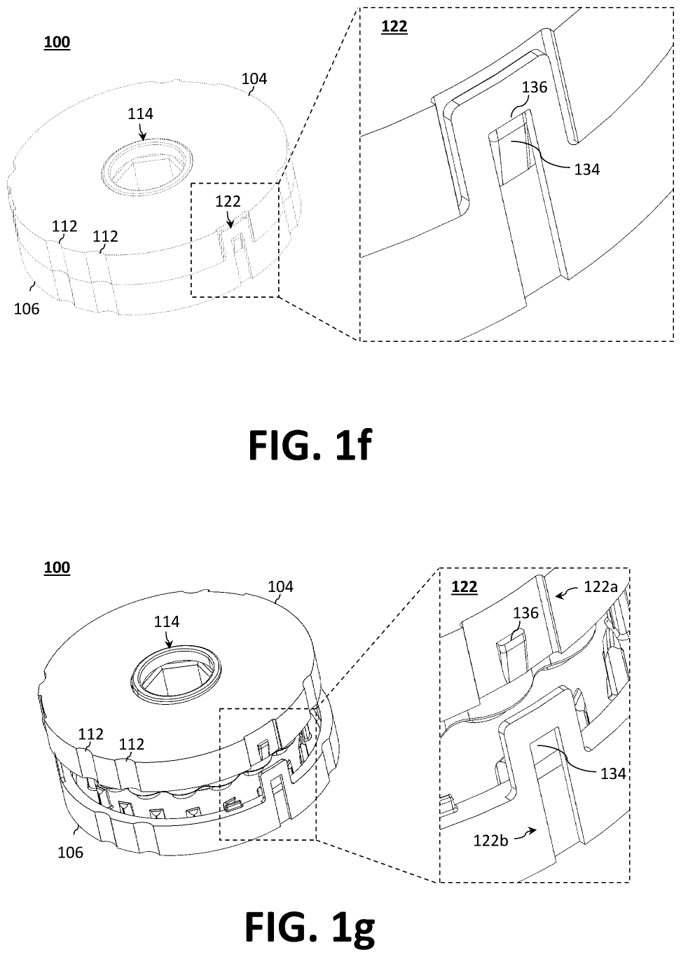

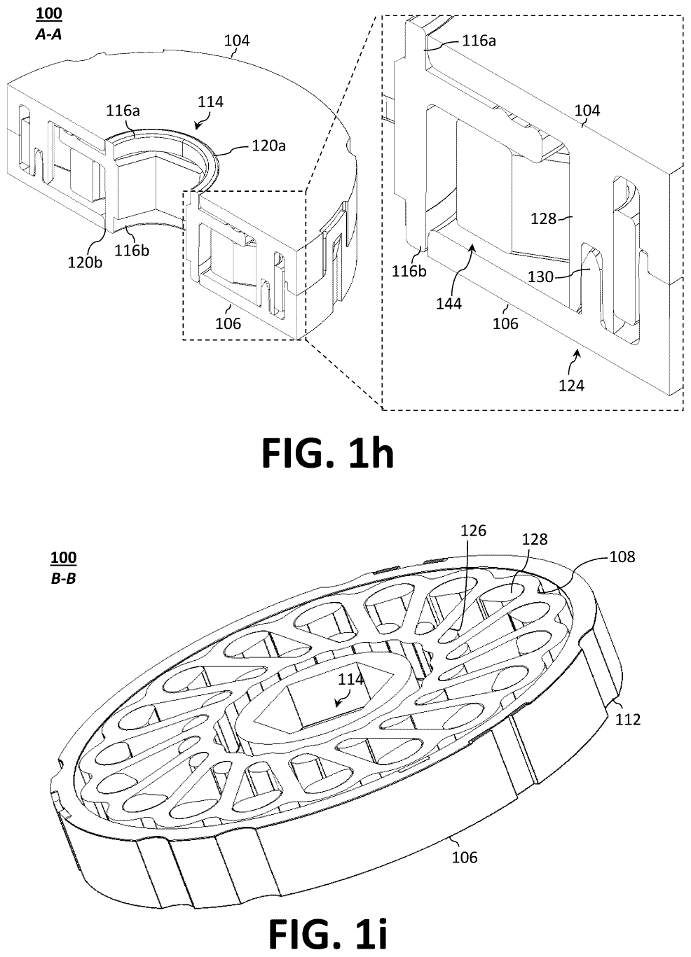

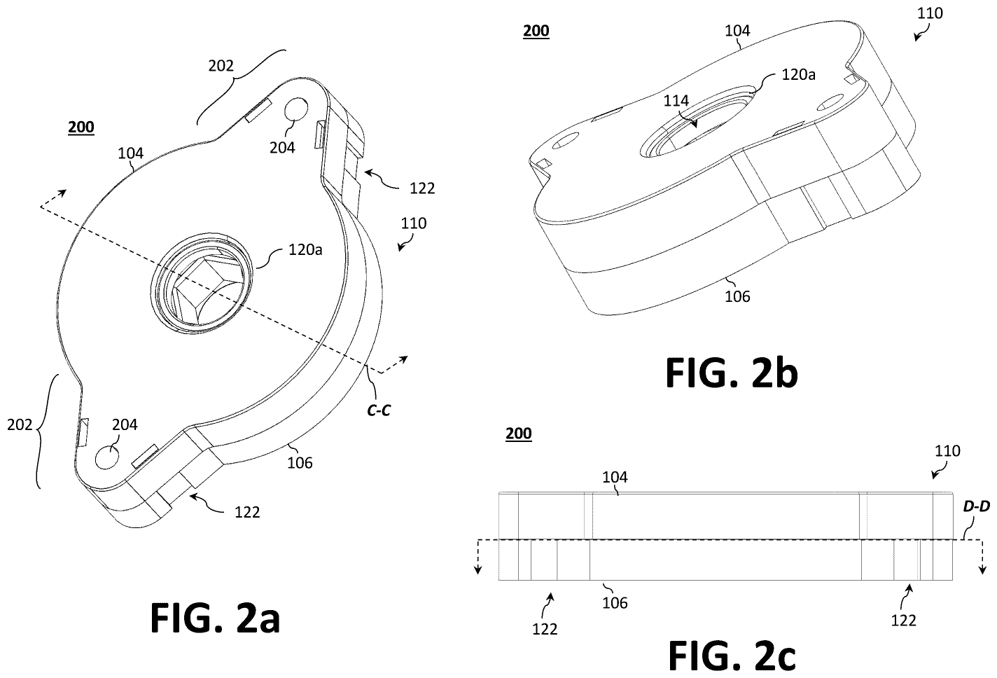

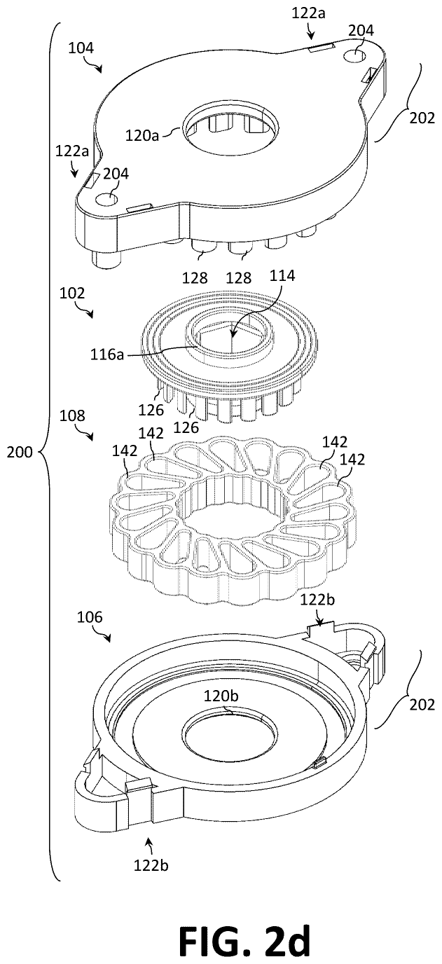

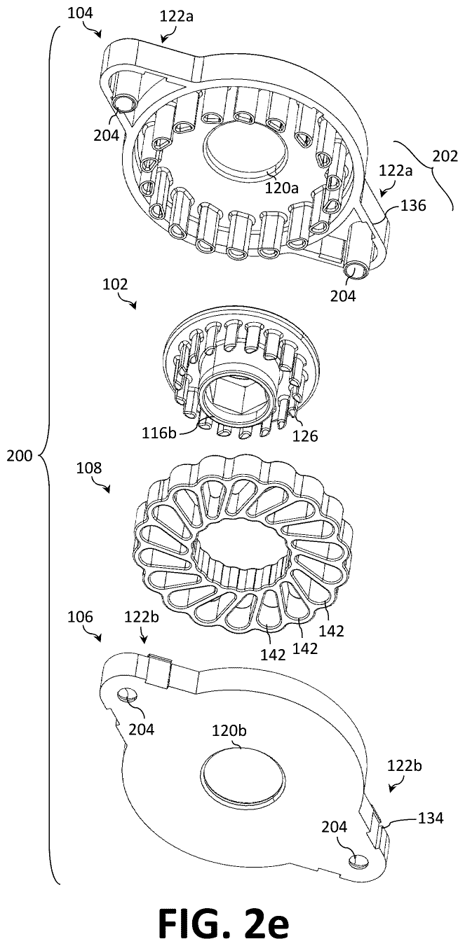

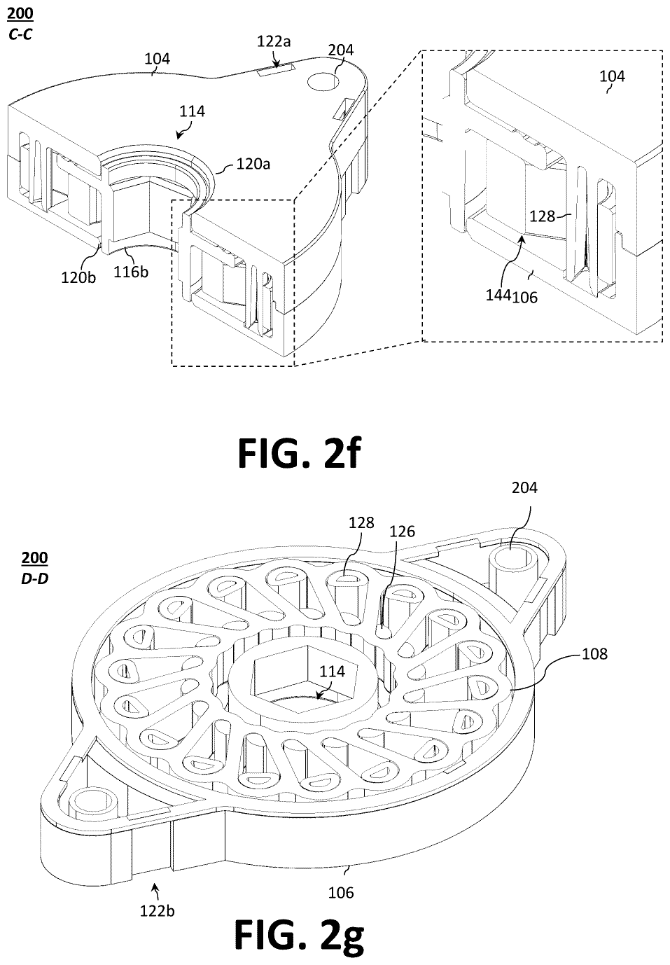

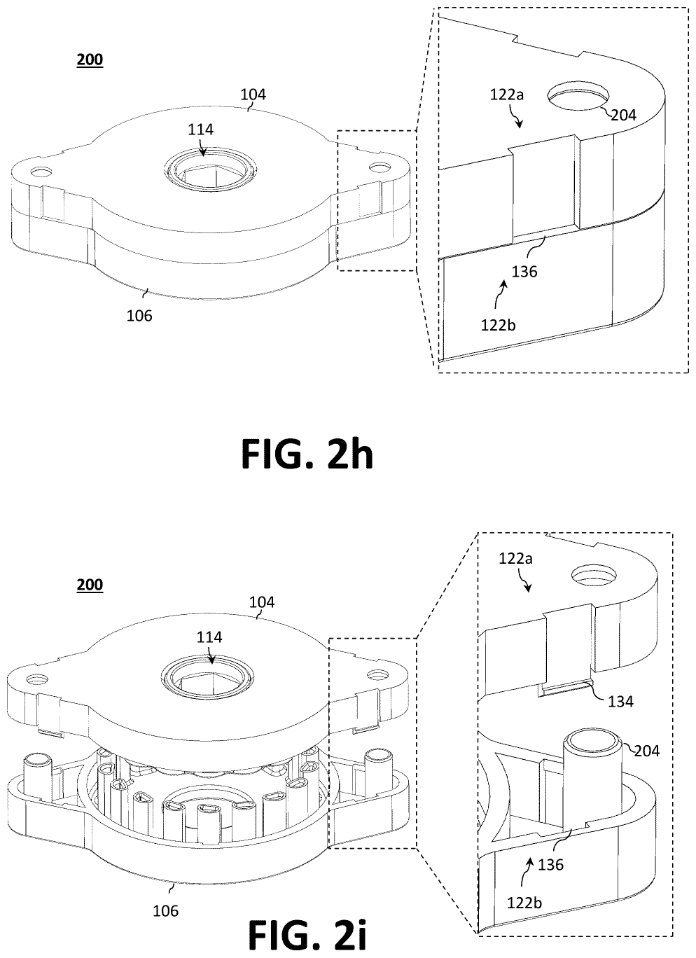

FIGS. 1a and 1b illustrate top perspective views of a dampener 100 in accordance with an aspect of this disclosure, while FIG. 1c illustrates a side elevational view of the dampener 100. FIGS. 1d and 1e illustrate topside and underside perspective assembly views of the dampener 100. FIGS. 1f and 1g illustrate top perspective assembled and assembly views of a snap assembly 122 of the dampener 100. Other examples are possible, including the dampener 200 described in connection with FIGS. 2a through 2i. The dampener 100 generally includes a core 102, a first housing element 104 (e.g., a first disc), a second housing element 106 (e.g., a second disc), and a tensile member 108. The first housing element 104 and the second housing element 106 are configured to connect to one another to form or define a housing assembly 110 having a cavity 144 therein. The housing assembly 110 is illustrated as symmetrical, thus allowing the housing assembly 110 flipped during assembly to enable the same dampener 100 to be installed on either side of a vehicle seat and/or to provide clockwise and counter-clockwise operation, thus reducing part numbers. In the illustrated example, the housing assembly 110 defines a plurality of alignment grooves 112 along its sidewall at the perimeter. At illustrated, each of the alignment grooves 112 are vertical (i.e., parallel to the central axis 118). While the alignment grooves 112 are illustrated as having a semi-circle channel profile, other profile shapes are contemplated, including, for example, triangular profiles, diamond profiles, quadrilateral profiles, etc.

The core 102, which can also be referred to as a compression limiter, defines a central opening 114 disposed therethrough. The central opening 114 can be accessed and engaged via a shaft (e.g., a hex/shaped shaft, keyed shaft, etc.) from either side, thus further supporting clockwise or counter-clockwise operation. The first housing element 104 is disposed at a first collar 116a (at a first end) of the core 102 and the second housing element 106 is disposed at a second collar 116b (at a second end) of the core 102. The second collar 116b is opposite of the first collar 116a, with reference to an axial length AL of the core 102. The tensile member 108 is connected to and between core 102 and the second housing element 106 about the central axis 118. The core 102 is positioned within the cavity 144 of the housing assembly 110 between the first housing element 104 and the second housing element 106, such that the core 102 can rotate at least partially relative to the housing assembly 110 (e.g., the first housing element 104 and the second housing element 106). The core 102 is therefore able to rotate about the central axis 118, but dampened by the tensile member 108.

In use, the core 102 can be fixedly coupled with a first component (e.g., via the central opening 114), while the housing assembly 110 can be fixedly coupled with a second component (e.g., via the alignment grooves 112, fasteners, or the like). The alignment grooves 112 can prevent the housing assembly 110 from rotating within the recess and to serve as a poka-yoke to reduce error during assemble. For example, the alignment grooves 112 can be arranged (e.g., asymmetrically positioned along the edge/sidewall of the housing assembly 110) such that the housing assembly 110 can fit in the recess in only one orientation. In addition to or in lieu of the alignment grooves 112, the housing assembly 110 may define one or more fastener holes to facilitate attachment via fasteners (e.g., screws, bolts, etc.), an example of which is illustrated in connection with FIGS. 2a through 2i.

The core 102 may be generally cylindrical in shape (as illustrated); however, the core 102 may be formed in other shapes, such as a rectangular prism, hexagonal prism, octagonal prism, or the like. The core 102 may be elongated, such that the axial length AL is greater than its diameter. In one embodiment, the core 102 may be a barrel. The core 102 may be composed of any suitable material that may be advantageous as it will have a relatively low mass, be inexpensive to fabricate, and may also provide advantages in terms of a desired amount of friction generated between the core 102 and the tensile member 108. In a particular embodiment, the core 102 is can be made out of a hard polymeric material, such as polyvinylchloride (PVC), high-density polyethylene (HDPE), fluoroplastics (such as Teflon), polyamides (such as Nylons, especially Nylon 6, Nylon 66, Nylon 12, Nylon 13, and Nylon 11), polyethylene terephthalate (PET), polybutylene terephthalate (PBT), or polyoxymethylene (POM).

The first housing element 104 and second housing element 106 of the housing assembly 110 may be formed in any shape suitable for the application in which they are deployed. For example, as illustrated, the first housing element 104 and the second housing element 106 are both circular in shape such that the housing assembly 110 is generally cylindrical. As illustrated, the first housing element 104 define a first opening 120a sized and shaped to receive the first collar 116a, while the second housing element 106 define a second opening 120b sized and shaped to receive the second collar 116b. The first and second openings 120a, 120b serve as or define pivots in which the first and second collars 116a, 116b can rotate. In some embodiments, however, the housing elements 104, 106 may be rectangular, hexagonal, octagonal, or the like. The housing elements 104, 106 may be formed in any size suitable for the application. In some embodiments, the first housing element 104 and the second housing element 106 may have a diameter that is larger than the diameter of the core 102. The housing elements 104, 106 may be made of a hard, polymeric material, such as polyvinylchloride (PVC), high-density polyethylene (HDPE), fluoroplastics (such as Teflon), polyamides (such as Nylons, especially Nylon 6, Nylon 66, Nylon 12, Nylon 13, and Nylon 11), polyethylene terephthalate (PET), polybutylene terephthalate (PBT), polyoxymethylene (POM), or other suitable materials. Further, it is also contemplated that the first housing element 104 may be composed of a different material than the second housing element 106. Still further, it is envisioned that the housing elements 104, 106 may be composed of the same material as the core 102.

The first housing element 104 and the second housing element 106 are fixedly coupled to each other, via, for example, one or more snap assemblies 122 and/or press-fit assemblies 124 (e.g., a second boss 128 engaging a third boss 130). FIG. 1h illustrates a cross-sectional view taken along cut-line A-A (FIG. 1a) of an example press-fit assembly 124 of the dampener 100, while FIG. 1i illustrates a cross-sectional view taken along cut-line B-B (FIG. 1c) of an example snap assembly 122 for the dampener 100. Using one or more snap assemblies 122 and/or press-fit assemblies 124 can obviate the need for fasteners to couple the first housing element 104 and the second housing element 106 to each other, thus enabling a smaller outer diameter for the overall housing assembly 110 and also mitigating dirt/debris access to the cavity 144 by omitting fastener holes.

The illustrated dampener 100 includes a first set of bosses 126 (with each boss therein being a first boss 126) that may be part of a first solid component, a second set of bosses 128 (with each boss therein being a second boss 128) that may be part of a second solid component, and a third set of bosses 130 (with each boss therein being a third boss 130) that may be part of a third solid component. In an embodiment, the first, second, and third bosses 126, 128, 130 may form a single, integral, unitary piece with its respective first, second, and third solid components. In the illustrated examples, the first set of bosses 126 is formed on or integral with the core 102, the second set of bosses 128 is formed on or integral with the first housing element 104, and the third set of bosses 130 is formed on or integral with the second housing element 106.

The first set of bosses 126 is configured as a smaller ring of a first diameter surrounding the central opening 114 of core 102, while the second set of bosses 128 and the third set of bosses 130 are configured as a larger ring of a second diameter surrounding the first set of bosses 126. The second set of bosses 128 and the third set of bosses 130 are configured to mate with one another during assembly (e.g., as a press-fit assembly 124) and, therefore, share a diameter (i.e., the second diameter) and arrangement.

Each of the first bosses 126, the second bosses 128, and the third bosses 130 is illustrated as a protruding feature (e.g., a post, pin, column, cylinder, etc.) having a distal surface that is substantially flat and/or tapered. In some examples, one or more of the first bosses 126, the second bosses 128, and the third bosses 130 can be a substantially cylindrical shape or a substantially D-shaped cylindrical shape (e.g., a post with a D-shaped cross sectional profile). For example, the second bosses 128, are illustrated as a D-shaped cylindrical shape that is at least partially hollow define a cavity 132 configured to receive a corresponding third boss 130 via its distal surface. The first and third bosses 126, 130 can also be a D-shaped cylindrical shape, but may be solid. During assembly, each third boss 130 is inserted into a corresponding cavity 132 of a second boss 128 to form a press-fit assembly 124. In some examples, as illustrated, a distal end of the third boss 130 is tapered to assist with alignment when inserting the third boss 130 into a cavity 132 (e.g., during assemble of the first housing element 104 and the second housing element 106 to form the housing assembly 110).

The first bosses 126, the second bosses 128, and the third bosses 130 may have a first diameter from about 2 mm to about 12 mm, or from about 3 mm to about 10 mm. In a particular embodiment, the first bosses 126 may have a diameter from about 3 mm to about 8 mm or of about 4 mm. In the illustrated embodiments, the diameters of the first bosses 126, the second bosses 128, and the third bosses 130 are different. Specifically, the diameter of the second bosses 128 is greater than the diameter of the first bosses 126 and the diameter of the second bosses 128 is greater than the diameter of the third bosses 130. In the illustrated example, the diameter of the third bosses 142 is smaller than that of the second bosses 128 to enable the third bosses 142 to fit within the cavity 132 of a second boss 128. However, in an alternative embodiment, the first diameter may be the same as the second diameter. In another embodiment, the first diameter may be larger than the second diameter.

In addition to or in lieu of the one or more press-fit assemblies 124, the first housing element 1043 and the second housing element 106 can be fixedly coupled to each other, via, for example, one or more snap assemblies 122. Each of the one or more snap assemblies 122 includes a first snap component 122a that is configured to engage and retain a second snap component 122b. In the illustrated example, the first snap component 122a is coupled to or integrated with the first housing element 104 while the second snap component 122b is coupled to or integrated with the second housing element 106. The first and second snap components 122a, 122b can employed, for example, snaps, clips, tabs, windows or the like. In the illustrated example, the first snap component 122a defines a clip 134 portioned within a recessed portion, while the second snap component 122b defines tab with a window 136 configured to receive the clip 134. While the housing assembly 110 is illustrated as having three snap assemblies 122, additional or fewer snap assemblies 122 can be employed depending on the size of the housing assembly 110 and/or desired retentions strength.

The tensile member 108 comprises a plurality of bands 138 and internal voids 142, as well as an inner portion 144 and an outer portion 140. The plurality of bands 138 and internal voids 142 may be, for example, tear-drop shaped, hourglass-shaped, oval, etc. In an embodiment, a single tensile member 108 may have from 1 to 75 bands, or from 1 to 60 bands, or from 2 to 50 bands, or from 5 to about 50 bands, or from about 10 to about 45 bands, or from about 12 to about 40 bands, or from 15 to 35 bands. In a particular embodiment, a single tensile member 108 may have from 15 to 20 bands or about 18 bands. In an embodiment, the tensile member 108 may have approximately the same number of bands 138 and voids 142. Some embodiment a dampener 100 can include two or more tensile members 108. In some embodiment dampeners, two or more tensile members 108 can be stacked on top of each other, to increase torque and/or to change the spring rate by coupling a low durometer disk with a high modulus silicone disk. The tensile member 108 is configured such that bands 138 are disposed at an angle relative the core 102; however, in other configurations, the tensile member may be configured such that the bands 138 are not angled relative to the core 102 (or have a 0° angle to core).

The materials suitable for the tensile member 108 must be capable of repeatedly withstanding torsion loading (from 100% up to 600%) of rotation for at least 1000 hours at extreme temperatures (e.g., below −40° F. and above 185° F.). Additionally, suitable materials must satisfy certain material property constraints for a lightweight, compact rotational dampener. Non-limiting examples of materials suitable for use in the tensile member 108 include thermoset silicon elastomers, thermoset fluorine containing elastomers, and hybrids thereof.

In some embodiments, the tensile member 108 may be composed of a solid silicone polymer. The term “solid silicone polymer” as used herein, may refer to polymers composed primarily of silicone-containing monomeric units, such as siloxane. As such, solid silicone polymer may also be referred to as solid polysiloxane. In some embodiments, solid silicone polymers may be formed exclusively of silicone-containing monomeric units. In some embodiments, solid silicone polymers may be copolymers formed from one or more silicone-containing monomer units and one or more other co-monomeric units (i.e., a solid silicone copolymer). In some embodiments, solid silicone polymer may be internally crosslinked. In some embodiments, solid silicone polymers may be thermoset polymers. Solid silicone polymers, as used herein, experience elastic deformation rather than viscous flow. Specifically, tensile members 108 formed using the solid silicone polymers may have degree of polymerization of at least 100, or of at least 200, or of at least 500, or of at least 1000. In some embodiments, a solid silicone polymer that has been polymerization-grafted with fluorine-containing functional groups and/or co-polymerized with fluorine-containing comonomers may be well-suited for use in certain dampeners. Suitable materials are further described in connection with commonly-owned U.S. Patent Publication Nos. 2022/0056979A1 and 2023/0258241A1, each to Ooomen et al.

The tensile member 108 composed of the solid silicone polymer may have numerous advantages over tensile members 108 composed of other materials, especially metallic materials. The solid silicone polymer provides high amounts of torsional resistance while maintaining a low mass, and the ability to generate large amounts of friction between itself and other components of the dampener 100 (such as the core 102 and/or housing elements 104, 106).

The tensile member 108 may be connected to the core 102 and second housing element 106 in any suitable manner. For example, the tensile member 108 may be mechanically fastened or adhered to the core 102 and/or second housing element 106. In some embodiments, the tensile member 108 and the core 102 and/or second housing element 106 may be formed integrally as a unitary piece composed of a single material. For example, the tensile member 108 may be overmolded onto the core 102 via a 1-Shot Injection Molding or a 1-Shot Injection Molding process. Specifically, the solid silicone polymer may be polymerized within the mold itself. Alternatively, the solid silicone polymer may be polymerized in a barrel of an extruder and extruded onto a mold.

The tensile member 108, the first set of bosses 126, and the second set of bosses 128 are configured and positioned such that at least one first boss 126 and at least one second boss 128 are positioned with at least one void 142 of the tensile member 108. As best illustrated in FIG. 1i, one first boss 126 and one second boss 128 are positioned within each void 142 of the tensile member 108. Bands 138 separate the voids 142 from one another along the lateral sides of each void 142. Bands 138 also extend between the inner portion 144 and the outer portion 140 of the tensile member 108. In some embodiments, the bands 138 extend tangentially between the first circle 224 and the second circle 234.

In operation, the dampener 100 may be twisted such that the rotational force causes the core 102 and the housing elements 104, 106 to twist about the central axis 118 relative to one another. When the dampener 100 is twisted, the tensile member 108 is loaded and deforms (e.g., changes shape, stretches, etc.). The plastic deformation of the solid silicone polymer can act as dampening media via energy loss. Motion can be dampened through loss of energy from loading and unloading the tensile member 108 composed of solid silicone polymer. As the dampener 100 is rotated, the bands 138 of the tensile member 108 are stretched and/or otherwise deformed. The force required to stretch the bands 138 contributes, at least in part, to the torque required to rotate the core 102. In some embodiments, the plastic deformation of the tensile member 108 may be the primary dampening force provided by the dampener 100, which may contribute a greater dampening effect than any friction that may be generated by the dampener 100. In some embodiments, friction may be minimized such that plastic deformation of the tensile member 108 is substantially the only dampening effect provided by the dampener 100. The dampeners 100 may minimize internal friction through coating the tensile member 108 with a lubricant (e.g., grease or oil). Additionally or alternatively, other solid components of the dampener 100 may be coated with a lubricant to minimize friction.

Characteristics such as the size, shape, design and spacing of the components of a dampener 100 can affect the amount of dampening effect generated. For example, the diameter of the housing elements 104, 106 relative to the diameter of the core 102 and presence or absence of features that increase the surface area of the housing elements 104, 106 or axial faces of the core 102 (such as undulations, grooves, or corrugations) also affect the amount of dampening effect generated. Similarly, a cross-sectional area of the tensile member 108 affect the amount of dampening effect generated as larger tensile member 108 width will increase the contact area between the tensile member 108 and the core 102, thus increasing dampening effect. Additionally, the polish or surface condition of the molded cavity used to form the core 102 or tensile member 108, and thus the smoothness of these components, affects the amount of dampening effect generated. The material/resin selected for the core 102 also affects dampening effect. Moreover, the axial length AL of the core 102 can affect dampening effect. For example, a longer core 102 may generate more dampening effect.

In some embodiments, portions of the core 102, the first housing element 104, the second housing element 106, and the tensile members 108 contact each other and generate friction, which acts to slow the rotary motion provided by the dampener 100. This friction/interference can be controlled, in part, by the design and composition of the tensile member 108, the housing elements 104, 106, and the core 102. The tensile members 108 offer tensile resistance that is translated into a rotary motion resistance. In one example, the surfaces are abrasion sensitive and mitigate deflection of the bands 138. For example, the surfaces that contact the tensile member 108 (e.g., the bosses) can be highly polished to reduce friction, thus mitigating damage to and deflection of the tensile member 108.

FIGS. 2a and 2b illustrate top perspective views of a dampener 100 in accordance with an aspect of this disclosure, while FIG. 2c illustrates a side elevational view of the dampener 100. FIGS. 2d and 2e illustrate topside and underside perspective assembly views of the dampener 100. FIG. 2f illustrates a cross-sectional view taken along cut-line C-C (FIG. 2a) of a press-fit assembly 124 of the dampener 100. FIG. 2g illustrates a cross-sectional view taken along cut-line D-D (FIG. 2c) of the dampener 100. FIGS. 2h and 2i illustrate top perspective assembled and assembly views of a snap assembly 122 of the dampener 100.

The dampener 200 of FIGS. 2a through 2i is substantially similar to the dampener 100 of FIGS. 1a through 1i, with the exception of the housing assembly 110. As illustrated, the core 102 and the tensile member 108 are identical to the above-described core 102 and tensile member 108. In this example, however, the housing assembly 110 includes a pair of ear portions 202, each of which defines a fastener hole 204. The fastener hole 204 can serve as a through hole to attach the dampener 100 to a component or to simply couple the first housing element 104 to the second housing element 106. As illustrated, the second housing element 106 omits the third bosses 130 in favor of the fasteners via the fastener holes 204; however, it is contemplated that one or more features of the dampener 100 can be incorporated with the dampener 200.

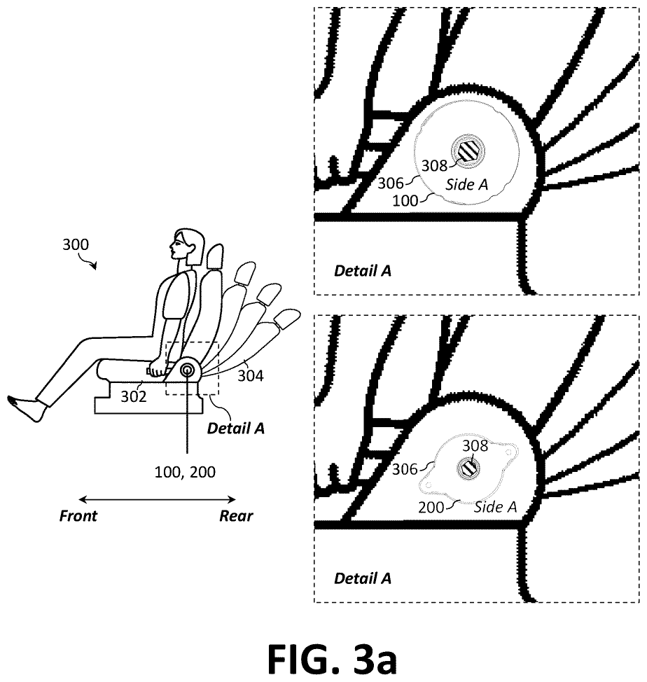

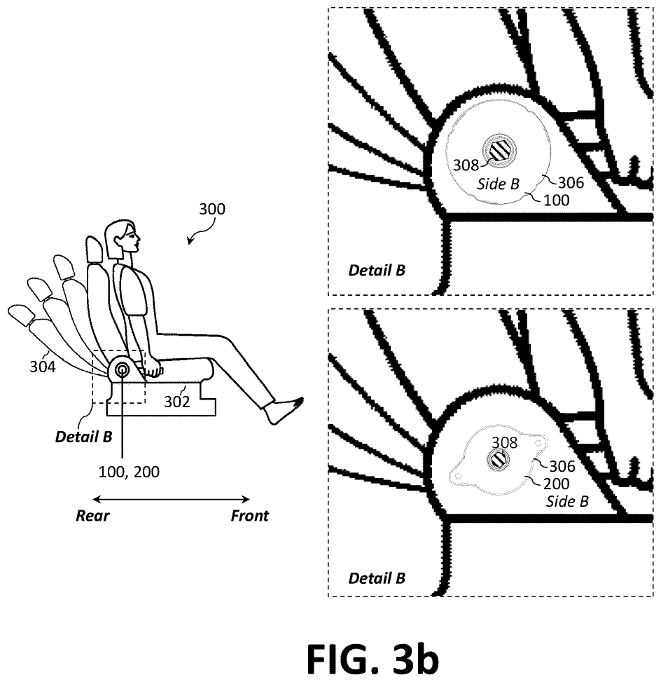

FIGS. 3a and 3b illustrate the dampeners 100, 200 installed in a vehicle seat 300. Specifically, FIG. 3a illustrates the dampeners 100, 200 installed on the left side of the vehicle seat 300 (with reference to the direction of travel), while FIG. 3b illustrates the dampeners 100, 200 installed on the right side of the vehicle seat 300 (with reference to the direction of travel). In one example, the first component is a first seat component (e.g., a seat base 302) and the second component is a second seat component (e.g., a seat back rest 304). The first component defines a recess 306 with a profile that compliments the housing assembly 110 and the alignment grooves 112, while the second component can include, for example, a shaft 308 or fastener configured to engage the central opening 114.

As noted previously, the housing assemblies 110 of the dampeners 100, 200 can be symmetrical, thus allowing the dampeners 100, 200 to be effectively flipped during assembly to enable the same dampener 100, 200 to provide a force is a desired direction (e.g., whether toward the front or rear of the vehicle seat 300) such that the same dampener 100, 200 can be installed on either the left or right sides of the vehicle seat 300 (or to simply reverse the direction of the force, if desired). For example, with reference to FIG. 3a, when the dampener 100, 200 is installed on the left side of the vehicle seat 300 in the recess 306 with Side A facing outward (as illustrated in Detail A), the core 102 (and shaft 308) can provide a force in a desired direction (e.g., toward a front of the vehicle seat 300). Conversely, with reference to FIG. 3b, when the dampener 100, 200 is installed on the right side of the vehicle seat 300 in the recess 306 with Side B facing outward (as illustrated in Detail B), the core 102 (and shaft 308) can provide a force in a direction to match or compliment that of a dampener 100, 200 installed on the left side (e.g., toward a front of the vehicle seat 300).

The above-cited patents and patent publications are hereby incorporated by reference in their entirety. While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A rotational spring dampener, comprising:
a core comprising an opening therethrough and a first plurality of bosses;
a first housing element comprising a second plurality of bosses;
a second housing element comprising a third plurality of bosses,
wherein the first housing element and the second housing element form a housing assembly having a cavity therein, and
wherein the core is configured to pivot relative to the housing assembly; and
a tensile member positioned within the cavity to dampen movement of the core relative to the housing assembly,
wherein the tensile member is connected to the core via the first plurality of bosses and to the first housing element via the second plurality of bosses, and
wherein the tensile member comprises a solid silicon polymer.

2. The rotational spring dampener of claim 1, wherein the housing assembly comprising one or more alignment grooves.

3. The rotational spring dampener of claim 1, wherein the first housing element and the second housing element are coupled to one another to form the housing assembly via one or more snap assemblies.

4. The rotational spring dampener of claim 3, wherein the one or more snap assemblies comprises a first snap component coupled to the first housing element and a second snap component coupled to the second housing element.

5. The rotational spring dampener of claim 4, wherein one of the first snap component and the second snap component includes a clip and another one of the first snap component and the second snap component includes a window configured to engage the clip.

6. The rotational spring dampener of claim 3, wherein the housing assembly is generally cylindrical and defines a sidewall, wherein the one or more snap assemblies are positioned on the sidewall.

7. The rotational spring dampener of claim 1, wherein each of the second plurality of bosses defines a cavity configured to receive one of the third plurality of bosses to define a press-fit assembly.

8. The rotational spring dampener of claim 7, wherein each of the third plurality of bosses comprise a distal end that is tapered.

9. The rotational spring dampener of claim 1, wherein the housing assembly is configured for installation in a recess of a vehicle seat in a first position where the first housing faces outwardly and a second position where the second housing faces outwardly.

10. The rotational spring dampener of claim 1, wherein exterior surfaces of the first plurality of bosses and the second plurality of bosses are polished to reduce friction with the tensile member.

11. A rotational spring dampener, comprising:
a core comprising an opening therethrough and a first plurality of bosses;
a first housing element comprising a second plurality of bosses;
a second housing element configured to couple with the first housing element via one or more snap assemblies to form a housing assembly having a cavity therein, wherein the core is configured to pivot relative to the housing assembly; and
a tensile member positioned within the cavity to dampen movement of the core relative to the housing assembly,
wherein the tensile member is connected to the core via the first plurality of bosses and to the first housing element via the second plurality of bosses, and
wherein the tensile member comprises a solid silicon polymer.

12. The rotational spring dampener of claim 11, wherein the housing assembly comprising one or more alignment grooves configured to serve as a poka-yoke.

13. The rotational spring dampener of claim 11 wherein the one or more snap assemblies comprises a first snap component coupled to the first housing element and a second snap component coupled to the second housing element.

14. The rotational spring dampener of claim 13, wherein one of the first snap component and the second snap component includes a clip and another one of the first snap component and the second snap component includes a window configured to engage the clip.

15. The rotational spring dampener of claim 1, wherein each of the second plurality of bosses defines a cavity configured to receive one of a third plurality of bosses formed on the second housing element to define a press-fit assembly.

16. The rotational spring dampener of claim 15, wherein each of the third plurality of bosses comprise a distal end that is tapered.

17. The rotational spring dampener of claim 11, wherein exterior surfaces of the first plurality of bosses and the second plurality of bosses are polished to reduce friction with the tensile member.

18. A rotational spring dampener, comprising:
a core comprising an opening therethrough and a first plurality of bosses;
a first housing element comprising a second plurality of bosses;
a second housing element configured to couple with the first housing element via one or more snap assemblies to form a housing assembly having a cavity and a pair of ear portions, wherein the core is configured to pivot relative to the housing assembly and each of the pair of ear portions defines a fastener hole; and
a tensile member positioned within the cavity to dampen movement of the core relative to the housing assembly,
wherein the tensile member is connected to the core via the first plurality of bosses and to the first housing element via the second plurality of bosses, and
wherein the tensile member comprises a solid silicon polymer.

19. The rotational spring dampener of claim 18, wherein each of the second plurality of bosses defines a cavity configured to receive one of a third plurality of bosses formed on the second housing element to define a press-fit assembly.

20. The rotational spring dampener of claim 18, wherein each of the first plurality of bosses and the second plurality of bosses is shaped as a D-shaped cylindrical.
